(19) United States
(12) Patent Application Publication
(10) Pub. No.: US 2004/0174779 A1
(43) Pub. Date: Sep. 9, 2004

(54) Optical pickup in which at least one of a reflecting mirror and a beam splitter has a function of a phase difference plate

(75) Inventors: Satoshi Ajiki, Yamagata-shi (JP); Kouichi Hosoya, Murayama-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Mitsumi Electric Co. Ltd., Tokyo (JP)

(21) Appl. No.: 10/787,448

(22) Filed: Feb. 25, 2004

(30) Foreign Application Priority Data
Mar. 3, 2003 (JP) 55385/2003

(51) Int. Cl. G11B 7/00

(52) U.S. Cl. 369/44.14

(57) ABSTRACT

In an optical pickup provided with an optical system including a reflecting mirror and a beam splitter, at least one of the reflecting mirror and the beam splitter having a base member and a film member attached to the base member to introduce a phase difference between an incident laser beam and an outgoing beam. A laser beam is emitted or radiated from a semiconductor laser. The laser beam is converged through the optical system to be focused on a signal recording surface of an optical disk. A return beam from the signal recording surface is detected through the optical system by a photodetector.

This invention claims priority to prior Japanese application JP 2003-55385, the disclosure of which is incorporated herein by reference.

### BACKGROUND OF THE INVENTION

The present invention relates to an optical pickup contained in an optical disk apparatus to perform recording and reproducing operations upon an optical recording medium (optical disk) such as a CD and a DVD.

As well known in the art, an optical pickup is an apparatus for carrying out information recording (writing) and reproducing (reading) operations and generally comprises a semiconductor laser element as a light source, an objective lens as an optical system, and a photodetector as optical detecting means. In the information recording (writing) operation, a laser beam emitted or radiated from the semiconductor laser element is converged by the objective lens to be focused on a signal recording surface of an optical disk. An information erasing operation is carried out in the similar manner. In the information reproducing operation, a reflected beam (return beam) reflected by the signal recording surface is detected by the photodetector.

As known in the art, the laser beam emitted or radiated from the semiconductor laser element has a polarization direction and generally has an elliptical shape with a predetermined beam divergent angle. Utilizing the fact that the laser beam has an elliptical shape, an elliptical spot by the laser beam is formed on the signal recording surface of the optical disk. In view of the information recording, the information erasing, and the information reproducing operations mentioned above, it is preferable to preliminarily determine a direction of a long axis (major axis) of the elliptical spot with respect to the optical disk.

The optical pickup of the type comprises a beam splitter among the semiconductor laser element, the optical disk, and the photodetector. The beam splitter serves to separate the laser beam incident thereto into a reflected beam and a transmitted beam at a specific ratio. The specific ratio is determined by the polarization direction of the laser beam.

The polarization direction of the laser beam is coincident with the direction of the long axis of the elliptical spot. Therefore, the specific ratio can not freely be determined to a desired value. Once the direction of the long axis of the elliptical spot is determined with respect to the optical disk, the ratio of the reflected beam and the transmitted beam is consequently determined. Thus, it is impossible to make the specific ratio have an optimum value.

For example, Japanese Patent Application Publication (JP-A) No. 2002-230822 corresponding to European Patent Publication EP 1 229 526 A2 teaches a phase difference plate disposed between the semiconductor laser element and the objective lens to be rotatable around an optical axis. The phase difference plate serves to introduce a phase difference between an incident laser beam and an outgoing beam in accordance with a rotation angle and may be called a phase retarding plate. As the phase difference plate, a ½ wave plate or a ¼ wave plate may be used. By the use of the phase difference plate, it is possible to form an angle between the direction of the long axis of the elliptical spot and the polarization direction of the laser beam. Therefore, the ratio between the reflected beam and the transmitted beam separated by the beam splitter can freely be determined to any desired value.

However, following the reduction in thickness of the optical pickup, the freedom in mounting position of the phase difference plate is decreased, increasing the difficulty in mounting the phase difference plate between the semiconductor laser element and the objective lens. In other words, presence of the phase difference plate inhibits the reduction in thickness of the optical pickup.

### SUMMARY OF THE INVENTION

It is therefore an object of the present invention to provide an optical pickup which can easily be reduced in thickness by forming an angle between a direction of a long axis of an elliptical spot and a polarization direction of a laser beam.

It is another object of the present invention to provide an optical pickup which can be produced from a reduced number of parts through a reduced number of assembling steps.

Other objects of the present invention will become clear as the description proceeds.

According to an aspect of the present invention, there is provided an optical pickup in which a laser beam emitted or radiated from a semiconductor laser is converged through an optical system to be focused on a signal recording surface of an optical disk and a return beam from the signal recording surface is detected through the optical system by a photodetector. The optical system comprises a reflecting mirror and a beam splitter. At least one of the reflecting mirror and the beam splitter comprises a base member and a film member attached to the base member to introduce a phase difference between an incident laser beam and an outgoing beam.

### BRIEF DESCRIPTION OF THE DRAWING

FIG. 1 is a plan view of a characteristic part of an optical pickup according to an embodiment of the present invention;

FIG. 2 is a front view of the characteristic part of the optical pickup illustrated in FIG. 1;

FIG. 3A is a plan view of a laser diode which may be used in the optical pickup illustrated in FIG. 1 and 2;

FIG. 3B is a front view of the laser diode;

FIG. 3C is a left side view of the laser diode;

FIG. 4A is a front view of a characteristic part of a beam splitter which may be used in the optical pickup illustrated in FIGS. 1 and 2;

FIG. 4B is a plan view of a characteristic part of another beam splitter which may be used in the optical pickup illustrated in FIGS. 1 and 2;

FIG. 4C is a plan view of a characteristic part of still another beam splitter which may be used in the optical pickup illustrated in FIGS. 1 and 2;

FIG. 5A is a plan view of a characteristic part of a reflecting mirror which may be used in the optical pickup illustrated in FIGS. 1 and 2;

FIG. 5B is a plan view of a characteristic part of another reflecting mirror which may be used in the optical pickup illustrated in FIGS. 1 and 2;

FIG. 5C is a plan view of a characteristic part of still another reflecting mirror which may be used in the optical pickup illustrated in FIGS. 1 and 2; and

FIG. 6 is a graph showing the change in polarization state at the reflecting mirror.

### DESCRIPTION OF THE PREFERRED EMBODIMENTS

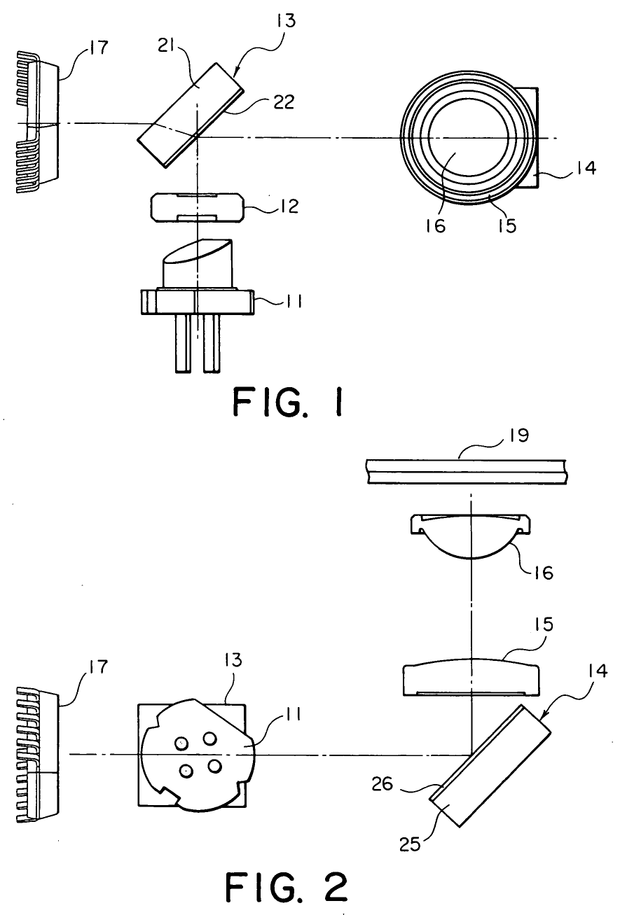

Referring to FIGS. 1 and 2, description will be made of a characteristic part of an optical pickup according to an embodiment of this invention.

The optical pickup illustrated in the figure comprises a semiconductor laser element, i.e., a laser diode 11, a diffraction grating 12, a beam splitter 13, a reflecting mirror 14, a collimator lens 15, an objective lens 16, and a photodetector 17. A combination of the diffraction grating 12, the beam splitter 13, the reflecting mirror 14, the collimator lens 15, and the objective lens 16 forms an optical system of the optical pickup.

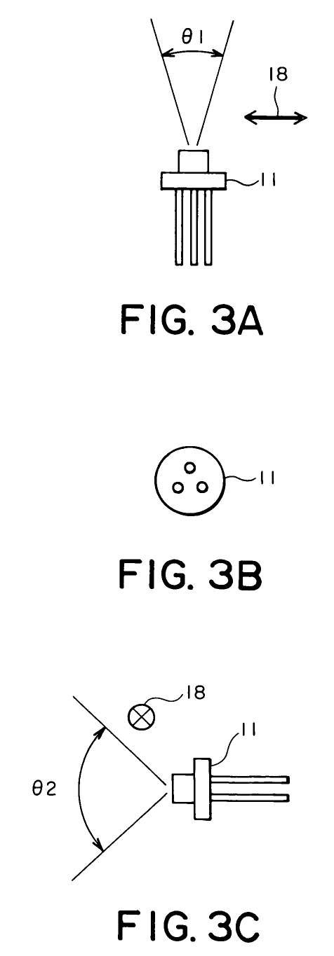

Referring to FIGS. 3A through 3C, the laser diode 11 will briefly be described.

The laser diode 11 emits or radiates a laser beam having a predetermined polarization direction 18. The laser beam emitted or radiated from the laser diode 11 has an elliptical shape with a predetermined beam divergent angle.

The laser beam has a polarization direction which is parallel to an active layer of the laser diode 11.

The predetermined beam divergent angle of the laser beam is different in the direction parallel to the active layer of the laser diode 11 and in a direction perpendicular to the active layer of the laser diode 11. More specifically, a laser radiation angle θ1 in the direction parallel to the active layer is relatively small as shown in FIG. 3A. On the other hand, a laser radiation angle θ2 in the direction perpendicular to the active layer is relatively large as shown in FIG. 3C.

Turning back to FIGS. 1 and 2, the description will be continued.

The diffraction grating 12 serves to separate the laser beam emitted or radiated from the laser diode 11 into multiple laser beams. The beam splitter 13 serves to reflect the multiple laser beams from the diffraction grating 12 and to transmit a return beam or a reflected beam from an optical disk 19. Thus, the beam splitter 13 has a function of separating an incident laser beam into a reflected beam and a transmitted beam. The reflecting mirror 14 is a 45° reflecting mirror and serves to perpendicularly turn or deflect the multiple laser beams reflected by the beam splitter 13 so that the multiple laser beams are directed towards the collimator lens 15. The collimator lens 15 serves to convert the multiple laser beams into a parallel beam. The objective lens 16 serves to converge or focus the parallel beam passing through the collimator lens 15 onto the optical disk 19.

As will later be described also, the reflected beam (return beam) reflected by the optical disk 19 passes through the objective lens 16 and the collimator lens 15, is perpendicularly turned or deflected by the reflecting mirror 14, and is incident to the beam splitter 13. The return beam transmitted through the beam splitter 13 is received by the photodetector 17.

Although not shown in FIGS. 1 and 2, the optical system of the optical pickup further includes a concave lens (magnifying lens) and a forward sensor. The beam splitter 13 may be called a half mirror.

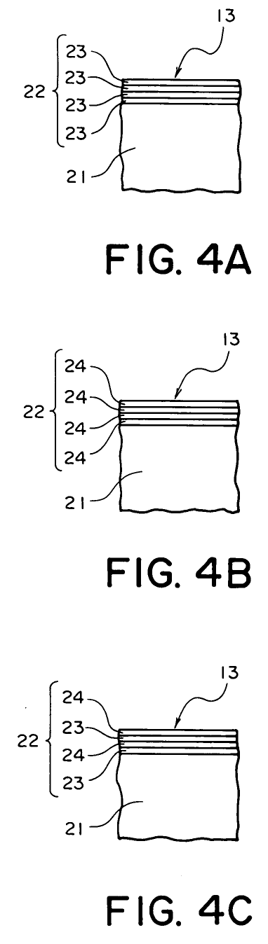

The beam splitter 13 comprises a base member 21, such as glass, and a film member 22 formed on the base member 21. The film member 22 comprises multiple layers laminated on one another. As the multiple layers of the film member 22, use may be made of multiple dielectric films 23 laminated on one another as illustrated in FIG. 4A, multiple metal films 24 laminated on one another as illustrated in FIG. 4B, or a combination of the multiple dielectric films 23 and the multiple metal films 24, for example, alternately laminated as illustrated in FIG. 4C.

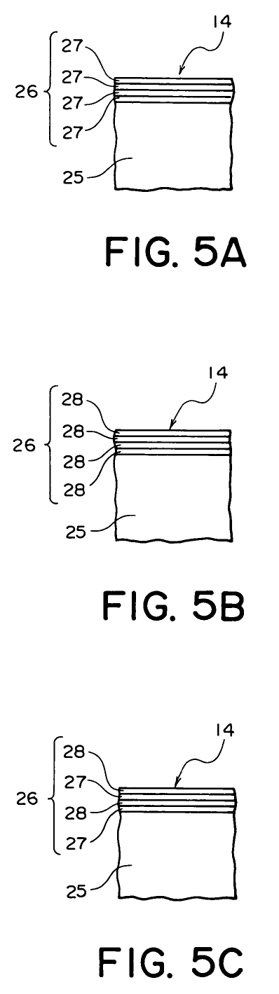

The reflecting mirror 14 comprises a base member 25, such as glass, and a film member 26 formed on the base member 25. The film member 26 comprises a plurality of layers laminated on one another. As the layers of the film member 26, use may be made of multiple dielectric films 27 laminated on one another as illustrated in FIG. 5A, multiple metal films 28 laminated on one another as illustrated in FIG. 5B, or a combination of the multiple dielectric films 27 and the multiple metal films 28, for example, alternately laminated as illustrated in FIG. 5C.

When a laser beam is incident to the dielectric films and/or the metal films laminated on the base member, such as glass, to be reflected or transmitted, a phase difference may be produced between an incident beam and a reflected or a transmitted beam. Noting the above, each of the beam splitter 13 and the reflecting mirror 14 is given a function corresponding to the phase difference plate mentioned above by controlling the change in phase by the dielectric films and/or the metal films.

In order to control the above-mentioned change in phase, the refractive index of each layer of the film member, the thickness of each layer, and a lamination structure of the layers are selected. Specifically, the layers of the film member are different in refractive index from one another. The thickness of the film member is selected to an optimum thickness. The number of layers and the order or lamination are appropriately selected.

For example, the material of each layer of the film member is selected from SiO₂, Si, TiO₂, and Al₂O₃. As the base member, use may be made of a white sheet glass known in the art. However, the base member need not be the white sheet glass but may be any other appropriate optical component of a complete reflection (mirror) type.

In case where the white sheet glass is used, the film member is preferably formed by vapor deposition in view of mass production. The film member may be produced by any other appropriate deposition technique, for example, sputtering.

In FIGS. 1 and 2, the laser beam emitted from the laser diode 11 forward in a horizontal direction is separated by the diffraction grating 12 into multiple laser beams. The multiple laser beams are perpendicularly turned or deflected by the beam splitter 13 to travel rightward in the horizontal direction. The beam splitter 13 serves to separate an incident laser beam into a reflected beam and a transmitted beam at a predetermined ratio. For example, 80% of the incident laser beam is reflected from the beam splitter 13 while 20% is transmitted though the beam splitter 13.

The multiple laser beams traveling rightward in the horizontal direction are reflected by a reflecting surface of the reflecting mirror 14 to be perpendicularly turned or deflected and travel upward in a vertical direction. The multiple laser beams are converted by the collimator lens 15 into a parallel beam which is converged through the objective lens 16 to be focused (irradiated) as a focused laser beam on the signal recording surface of the optical disk 19 being driven and rotated. At this time, an elliptical spot is formed by the focused laser beam on the signal recording surface of the optical disk 19. Thus, an information recording (writing) or an information erasing operation can appropriately be carried out upon the optical disk 19.

On the other hand, the reflected beam (return beam) from the signal recording surface of the optical disk 19 travels downward in the vertical direction, passes through the objective lens 16 and the collimator lens 15, and is reflected on a reflecting surface of the reflecting mirror 14 to be perpendicularly turned on deflected. Then, the reflected beam (return beam) travels leftward in the horizontal direction, passes through the beam splitter 13 and a concave lens (not shown), and is detected by the photodetector 17. Thus, it is possible to reproduce the information stored (recorded) in the optical disk 19.

In the foregoing, description has been made of the case where both of the beam splitter 13 and the reflecting mirror 14 are provided with the film members. Alternatively, only one of the beam splitter 13 and the reflecting mirror 14 may be provided with the film member.

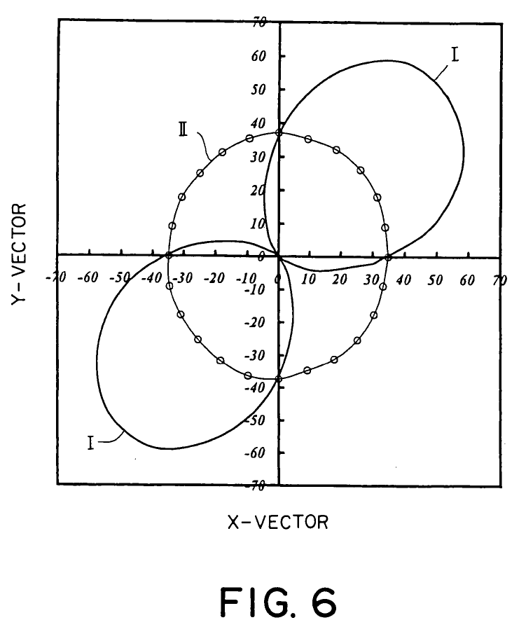

Referring to FIG. 6, description will be made of the change in polarization state at the reflecting mirror 14. In FIG. 6, an abscissa and an ordinate represent an X-vector and a Y-vector, respectively. The change in polarization state is shown for each of an incident beam I and a reflected beam II. The polarization state was observed by an optical analyzer.

As seen from FIG. 6, it is possible to give the reflecting mirror 14 a function corresponding to the phase difference plate. Specifically, an angle is formed between the polarization direction of the laser beam and the direction of a long axis of the elliptical spot. Depending upon the angle, the ratio between the reflected beam and the transmitted beam at the beam splitter 13 can be determined. Therefore, the optical pickup can easily be reduced in thickness. Further, the number of parts can be reduced so that the number of steps can be reduced.

While this invention has thus far been described in conjunction with the preferred embodiment thereof, it will be readily possible for those skilled in the art to put this invention into practice in various other manners. For example, although each of the film members 22 and 26 comprises four layers in FIGS. 4A-4C and 5A-5C, the number of the layers may be any one of three or less and five or more.

Japanese Patent Publication (JP-A) No. 2002-230822, the disclosure of which is herein incorporated by reference, discloses a phase difference plate having a function which corresponds to or is similar to that of each of the film members 22 and 26.

What is claimed is:

1. An optical pickup in which a laser beam emitted or radiated from a semiconductor laser is converged through an optical system to be focused on a signal recording surface of an optical disk and a return beam from the signal recording surface is detected through the optical system by a photodetector, the optical system comprising:
a reflecting mirror; and
a beam splitter;
at least one of the reflecting mirror and the beam splitter comprising:
a base member; and
a film member attached to the base member to introduce a phase difference between an incident laser beam and an outgoing beam.

2. The optical pickup according to claim 1, wherein the film member comprises a plurality of layers laminated on the base member.

3. The optical pickup according to claim 2, wherein the layers are different in refractive index from one another.

4. The optical pickup according to claim 1, wherein the film member comprises a dielectric film.

5. The optical pickup according to claim 1, wherein the film member comprises a metal film.

6. The optical pickup according to claim 1, wherein the film member comprises a combination of a dielectric film and a metal film.

7. The optical pickup according to claim 1, wherein the base member is formed by a white sheet glass.

8. The optical pickup according to claim 1, wherein the film member is made of a material selected from SiO₂, Si, TiO₂, and Al₂O₃.

9. The optical pickup according to claim 1, wherein the film member is formed on a surface of the base member by vapor deposition.

10. The optical pickup according to claim 1, wherein the film member is formed on a surface of the base member by sputtering.
